(19) United States
(12) Patent Application Publication
(10) Pub. No.: US 2009/0278023 A1
(43) Pub. Date: Nov. 12, 2009

(54) LOWER MOTOR LOCKING MOUNT

(75) Inventor: Richard J. Kent, Newbury, NH (US)

Correspondence Address: John A. Fortkort;Fortkort & Houston P.C., Building 1, Suite 500, 9442 N. Capital of Texas Hwy, Austin, TX, 78759, US

(73) Assignee: Fabworx Solutions, Inc.

(21) Appl. No.: 12/464,778

(22) Filed: May 12, 2009

Related U.S. Application Data
(60) Provisional application No. 61/127,446, filed on May 12, 2008.

(51) Int. Cl. F16M 13/02

(52) U.S. Cl. 248/672

(57) ABSTRACT

A robot is provided which comprises (a) a hub (311) disposed on a substrate (306); (b) a first motor (305) which operates a first arm by moving a first magnet (305) disposed within said hub; (c) a first housing element (331) for housing said first motor; (d) a first plate (321) disposed within said hub and attached to a first end of said housing element; and (e) a second plate (341) attached to a second end of said first housing element such that said substrate extends between said second plate and said hub.

This application claims the benefit of priority from U.S. Provisional Application No. 61/127,446, filed May 12, 2008, having the same title, and having the same inventor, and which is incorporated herein by reference in its entirety.

### FIELD OF THE DISCLOSURE

The present disclosure relates generally to robots, and more particularly to locking mechanisms for securing the motor of a robot in place.

### BACKGROUND OF THE DISCLOSURE

The use of robots is widespread in the semiconductor industry, due to their ability to process a large number of semiconductor wafers through many different processing technologies, and to perform repetitive tasks quickly and accurately. The use of robots is especially advantageous in portions of semiconductor fabrication lines where human handling of semiconductor wafers is inefficient or undesirable. For example, many semiconductor fabrication processes, such as etching, deposition, and passivation, occur in reaction chambers having sealed environments. The use of robots allows these environments to be carefully maintained in order to minimize the likelihood of contamination and to optimize processing conditions.

Modem semiconductor processing systems include cluster tools that integrate a number of process chambers together in order to perform several sequential processing steps without removing the substrate from the highly controlled processing environment. These chambers may include, for example, degas chambers, substrate pre-conditioning chambers, cooldown chambers, transfer chambers, chemical vapor deposition chambers, physical vapor deposition chambers, and etch chambers. The combination of chambers in a cluster tool, as well as the operating conditions and parameters under which those chambers are run, are selected to fabricate specific structures using a specific process recipe and process flow.

Once the cluster tool has been set up with a desired set of chambers and auxiliary equipment for performing certain process steps, the cluster tool will typically process a large number of substrates by continuously passing them, one by one, through a series of chambers or process steps. The process recipes and sequences will typically be programmed into a microprocessor controller that will direct, control and monitor the processing of each substrate through the cluster tool. Once an entire cassette of wafers has been successfully processed through the cluster tool, the cassette may be passed to yet another cluster tool or stand alone tool, such as a chemical mechanical polisher, for further processing.

One example of a known fabrication system of the type described above is the cluster tool 101 disclosed in U.S. Pat. No. 6,222,337 (Kroeker et al.), and reproduced in FIGS. 1-2 herein. The magnetically coupled robots 103, 153 disclosed therein are equipped with upper 105 and lower 107 robotic arms having a frog-leg type construction that are adapted to provide both radial and rotational movement of the robot blade 109 within a fixed plane. The radial and rotational movements can be coordinated or combined to allow for pickup, transfer and delivery of substrates from one location within the cluster tool to another location. For example, the robotic arm may be used to move substrates from one processing chamber to an adjacent chamber.

FIG. 1 is a schematic diagram of the integrated cluster tool 101 of Kroeker et al. Wafers or other substrates 102 are introduced into, and withdrawn from, the cluster tool 101 through a cassette loadlock 111. A robot 103 having a blade 109 is located within a chamber 113 of the cluster tool 101 and is adapted to transfer the substrates from one process chamber to another. These process chambers may include, for example, a cassette loadlock 115, a degas wafer orientation chamber 117, a preclean chamber 119, a PVD TiN chamber 121 and a cooldown chamber 123. The robot blade 109 is illustrated in the retracted position in which it can rotate freely within the chamber 113.

A second robot 153 is located in transfer chamber 163, and is adapted to transfer substrates between various chambers which may include, for example, a cooldown chamber 165, a preclean chamber 167, a CVD Al chamber 169 and a PVD AlCu processing chamber 171. The specific configuration of chambers illustrated in FIG. 1 is designed to provide an integrated processing system capable of both CVD and PVD processes in a single cluster tool. A microprocessor controller 171 is provided to control the fabricating process sequence, conditions within the cluster tool, and the operation of the robots 103, 153.

Robots of the type depicted in FIGS. 1-2 above are utilized, for example, in the ENDURA® and CENTURA® 200 nm/300 nm platforms sold by Applied Materials (Santa Clara, Calif.). As seen in FIG. 2, these robots 103 include a central hub 131, a pair of upper arms 105, and a pair of lower arms 107. The lower arms 107 are rotatingly attached to the hub 131 and are driven by servo drives housed within the hub 103.

### SUMMARY OF THE DISCLOSURE

In one aspect, a robot is provided which comprises (a) a hub disposed on a substrate; (b) a first motor which operates a first arm by moving a first magnet disposed within said hub; (c) a first housing element for housing said first motor; (d) a first plate disposed within said hub and attached to a first end of said housing element; and (e) a second plate attached to a second end of said first housing element such that said substrate extends between said second plate and said hub.

### BRIEF DESCRIPTION OF THE DRAWINGS

For a more complete understanding of the present disclosure and the advantages thereof, reference is now made to the following description taken in conjunction with the accompanying drawings in which like reference numerals indicate like features and wherein:

FIG. 1 is an illustration of a prior art cluster tool.

FIG. 2 is an illustration of a prior art robot.

FIG. 3 is an illustration, partially in section, of a prior art robot.

FIG. 4 is a top view of the robot of FIG. 3.

FIG. 5 is a side view, partially in section, of the robot of FIG. 3.

FIG. 6 is an enlarged view of the hub and magnetic ring of the robot of FIG. 3.

FIG. 7 is an enlarged view of the motor and magnetic plate of the robot of FIG. 3.

FIG. 8 is an illustration, partially in section, of one particular, non-limiting embodiment of a robot made in accordance with the teachings herein.

FIG. 9 is an enlarged view of the motor and magnetic plate of the robot of FIG. 8.

FIG. 10 is an enlarged view of the mounting assembly of the robot if FIG. 8.

FIG. 11 is an enlarged view of the first housing element of the robot if FIG. 8.

FIG. 12 is a top view of the first housing element of FIG. 11.

FIG. 13 is a side view of the second plate of the robot if FIG. 8.

FIG. 14 is a side view of the second plate of the robot if FIG. 8.

### DETAILED DESCRIPTION

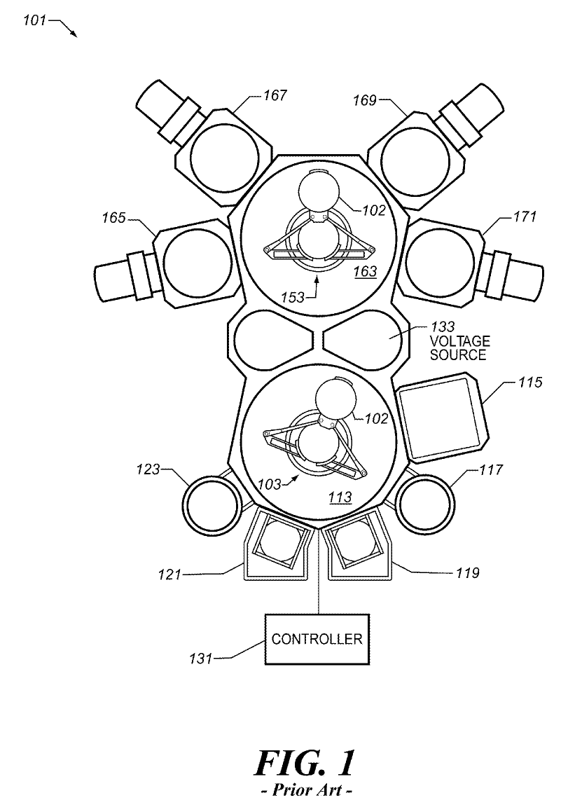

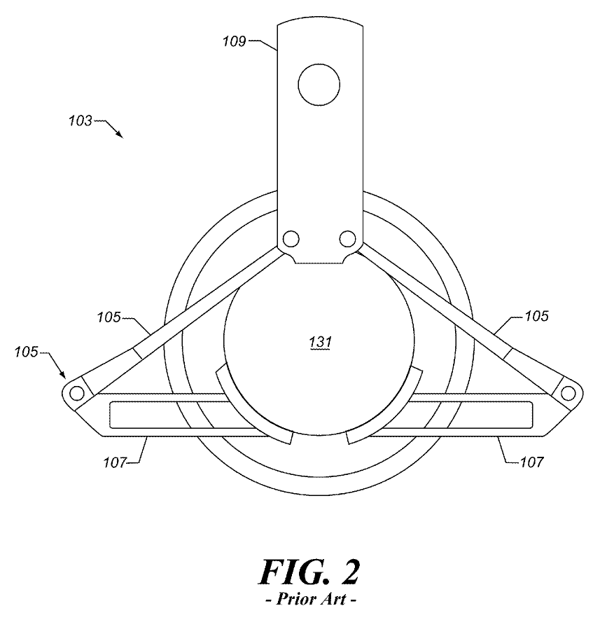

While the robots depicted in FIGS. 1-2 have some advantageous features, they also suffer from some infirmities. In particular, the design of these robots features a motor which is held in place by loose fitting contact positions created by the original equipment manufacturer. Because these contact positions are loose, they tend to wear over time, which causes the rotating motor assembly to position inaccurately.

In addition, these robots have an error associated with their operation which arises when the motor assembly “hops” out of its mounting position due to motor torque as a result of the aforementioned loose fitting connections. This hopping action can cause a jamming of the rotating motor magnetic plate inside of the hub of the device. When this occurs, the rotation of the motor is inhibited, thus resulting in a condition in which the motor “commanded to position” counts will not equal the motor “encoder counts”. When such a state is achieved, a systems fault results which shuts down the motor.

It has now been found that the foregoing problems may be addressed through the provision of a device that secures or locks down the motor assembly of the servo drive on such a robot (the robot may be, for example, the single arm robot known as the HP Robotic Arm). A device of this type may be utilized to improve the positional accuracy of the rotating motor assembly by tightening the original equipment manufacturer contact positions. Moreover, a device of this type may be utilized to prevent the motor assembly from hopping out of its mounting position due to loose fitting connections when it is subject to motor torque.

The devices and methodologies disclosed herein may be further understood with reference to the attached drawings. For the sake of simplicity, this explanation focuses on the lower motor of an HP Robotic Arm and its associated mount. However, it will be appreciated that a robotic assembly may have two or more such motors, and that the devices and methodologies described herein may be applied to any, or all, of these motors to enhance operational performance. It will further be appreciated that these devices and methodologies may be applied to various other robot systems as well.

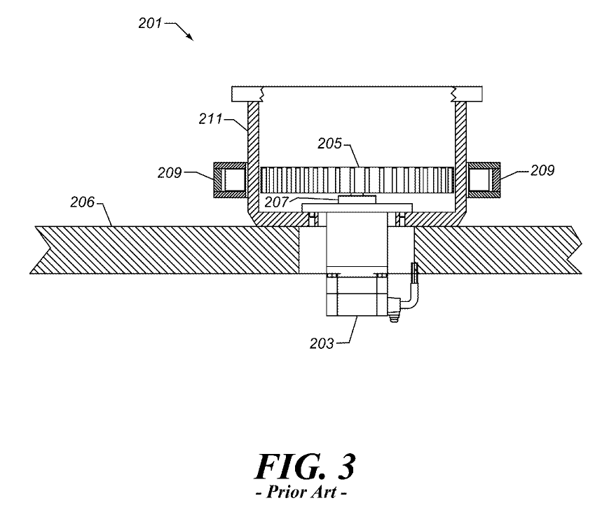

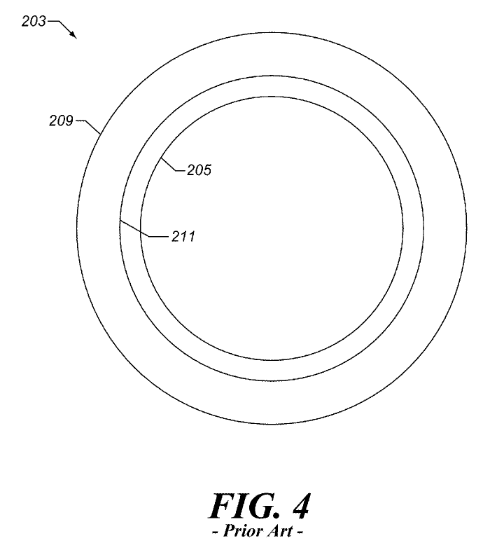

The function of the lower motor assembly 201 may be further appreciated with reference to FIGS. 3-4, which depict, respectively, a top view and side view (partially in cross-section) of the lower motor assembly 201 of a prior art robot. The motor 203 within this assembly 201 has a rotating shaft 207 with a magnetic plate 205 connected thereto. A complimentary magnetic ring 209 is located in the vacuum area of the assembly 201. A wall 211, referred to as the “soup bowl”, is disposed between the two sets of magnets.

In operation, the motor 203 rotates the magnetic plate 205, and the complimentary vacuum magnetic ring 209 rotates at the same time and at the same speed. One side of the robotic frog arm (which includes one upper arm 105 and one lower arm 107; see FIG. 2) is attached to the lower rotating vacuum magnetic ring 209. The second motor assembly, known as the top motor assembly, is not shown here but has the second side of the robotic frog arm (which includes the other upper arm 105 and lower arm 107; see FIG. 2) attached to it. The frog arm 103 (see FIG. 2) extends when the lower motor 203 rotates clockwise while the upper motor (not shown) rotates counter clockwise. Retraction is accomplished by rotating in the opposite directions. Theta motions (i.e., rotation of the robot) occur when both motors rotate in the same directions.

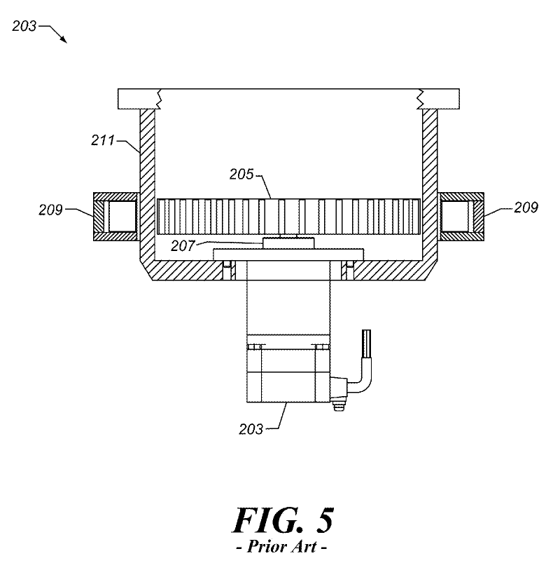

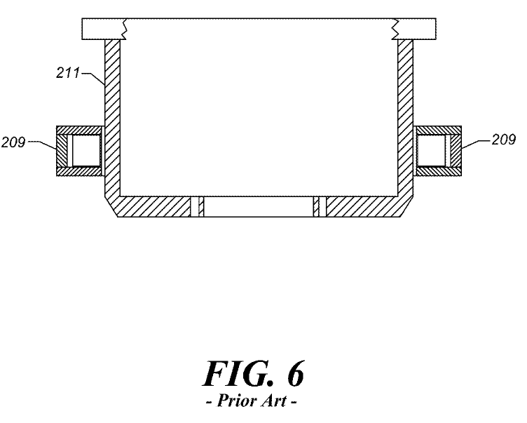

An example of the motor mount utilized in prior art motor mount assemblies is depicted in FIGS. 3-7. The assembly 201 shown therein utilizes a motor mount which comprises a thin plate 221 attached to the motor 203 and which has three dowel pins 223 extending from it. As seen in FIG. 5, these dowel pins 223 are utilized to register the lower motor assembly 203 to the soup bowl 211. In particular, the motor 203 is lowered into the soup bowl 211 such that the three dowel pins 223 are inserted into three corresponding holes 224 located in the bottom of the soup bowl. As seen in FIG. 3, the soup bowl 211 is attached to a substrate 206 which is typically the bottom of a cluster tools chamber.

It has now been found that there is an error in repeatability due to the way the lower motor 203 is mounted inside the soup bowl 211 in the prior art device of FIGS. 3-7. In particular, this connection is loose, thus permitting a certain amount of mechanical backlash. This backlash may be quantified as the distance one can rotate the arm 103, while the motor 203 is enabled, and measure a side to side motion. This backlash represents a mechanical error that the motor cannot compensate for, and thus gives rise to an inability on the part of the robot to accurately repeat an extension position.

A second type of error arises from motor torque. When this torque occurs, the entire motor assembly hops out of its location, and the rotating magnetic plate 205 jams inside of the soup bowl 211. This situation creates an unrecoverable error which is unacceptable to users of the robot.

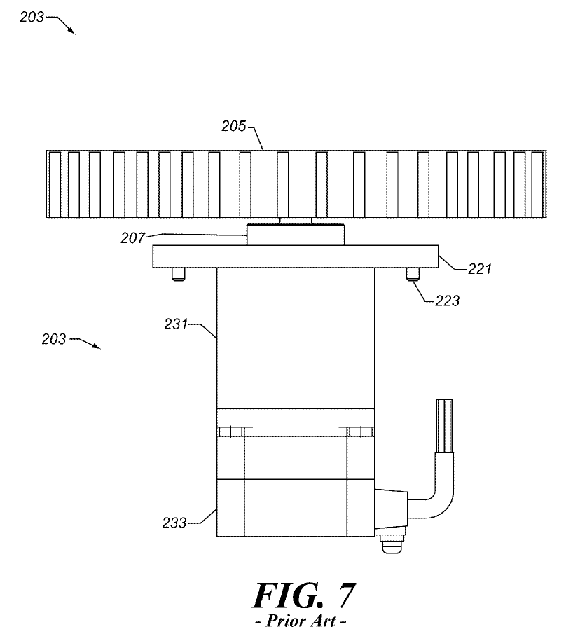

In order to remedy the foregoing problems, devices and methodologies are described herein which utilize a mount which is adapted to lock the motor of a robotic arm into place, thereby reducing or eliminating the backlash and motor torque that gives rise to placement errors. In the preferred embodiment of these devices and methodologies, the mounting plate 221 of the prior art (see FIG. 7) is replaced with a two-piece replacement mount that sandwiches the bottom portion of the soup bowl 211 and the substrate 206 between them, thereby locking the motor assembly into place. As explained in further detail below, the second plate of the mount may be attached to the bottom of the cluster tool so that, when the bottom plate is bolted to the mount, the two pieces sandwich the chamber floor between them, thereby creating a secure mounting condition for the entire motor assembly. In addition, one or more set screws may be provided for added security against lateral motion.

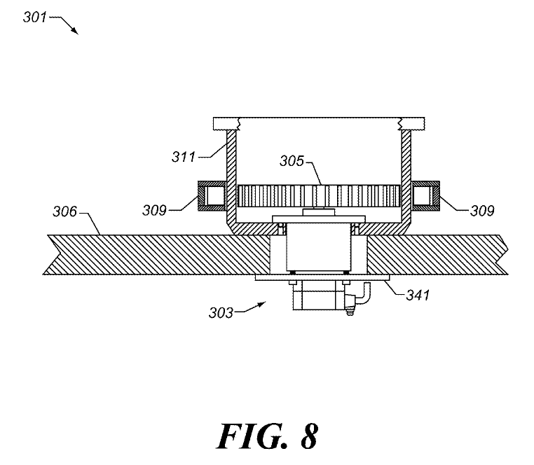

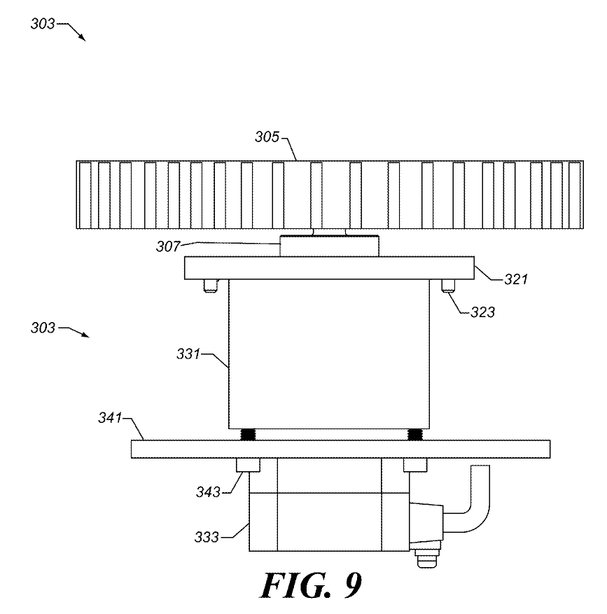

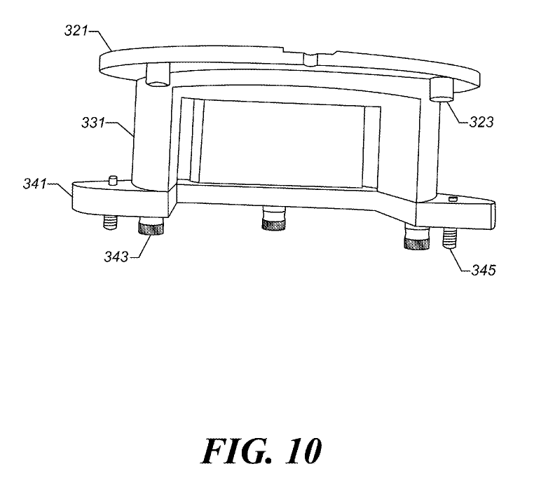

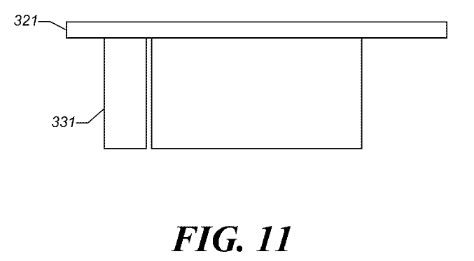

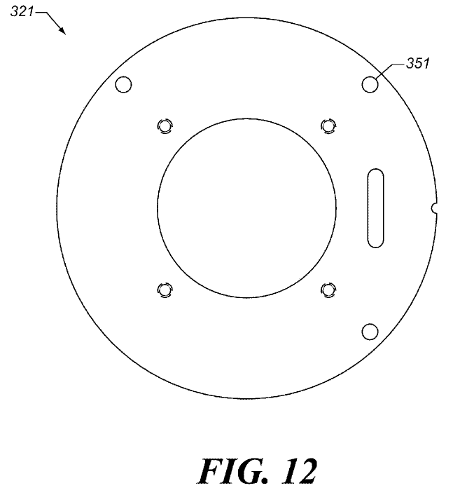

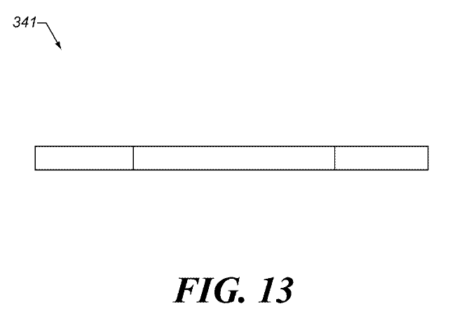

The devices and methodologies disclosed herein may be further appreciated with respect to the particular, non-limiting embodiment depicted in FIGS. 8-14. As with the prior art assembly depicted in FIGS. 3-7, the motor mount assembly 301 depicted therein comprises a thin plate 321 (see FIG. 9) attached to the motor 303 which has three dowel pins 323 extending from it. As seen in FIG. 8, these dowel pins 323 are utilized to register the lower motor assembly 303 to the soup bowl 311. In particular, the motor 303 is lowered into the soup bowl 311 in such a way that the three dowel pins 323 are inserted into three corresponding holes 324 located in the bottom of the soup bowl 311. As seen in FIG. 8, the soup bowl 311 is attached to a substrate 306 which is typically the bottom of a cluster tools chamber.

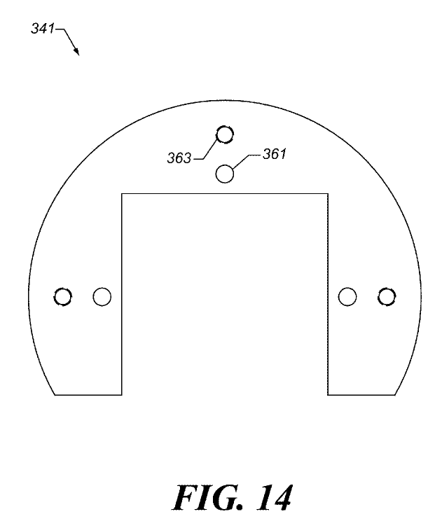

Unlike the prior art assembly depicted in FIGS. 3-7, however, the motor mount assembly 301 depicted in FIGS. 8-14 comprises a two-piece mount which, in addition to upper plate 321, also comprises a lower plate 341 (shown in greater detail in FIG. 14) which is disposed between the upper 331 and lower 333 portions of the motor assembly 303 (see, e.g., FIG. 9) and which is attached to the bottom of the cluster tool. As seen in FIG. 8, the bottom portion of the soup bowl 311 and the substrate 306 (typically the chamber floor) are sandwiched between the upper 321 and lower 341 plates, thereby securely locking the motor mount assembly 301 into place and eliminating the sources of error noted above which arise from motor torque and backlash.

With reference to FIG. 14, the lower plate 341 has a central opening 365 through which the motor assembly 303 extends. The lower plate 341 further comprises first 361 and second 363 sets of apertures. The first set of apertures 361 accommodate a set of bolts 343 (see FIG. 9) which bound the upper portion 331 of the motor assembly to the substrate 341. The second set of apertures 363 accommodate a series of set screws which may be provided in some embodiments for added security against lateral motion.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A robot, comprising:
a hub disposed on a substrate;
a first motor which operates a first arm by moving a first magnet disposed within said hub;
a first housing element for housing said first motor;
a first plate disposed within said hub and attached to a first end of said housing element; and
a second plate attached to a second end of said first housing element such that said substrate extends between said second plate and said hub.

2. The robot of claim 1, further comprising a second housing element, wherein said first housing element is disposed on a first side of said second plate, and wherein said second housing element is disposed on a second side of said second plate.

3. The robot of claim 2, wherein said first and second sides of said second plate form first and second major surfaces of said second plate.

4. The robot of claim 1, wherein said first magnet is a magnetic plate.

5. The robot of claim 4, wherein said first motor rotates said first magnetic plate.

6. The robot of claim 5, wherein said first magnetic plate is disposed within said hub and is magnetically coupled to a first rotatable ring disposed on the exterior of said hub.

7. The robot of claim 6, wherein said first rotatable ring is connected to a first set of robotic arms.

8. The robot of claim 1, wherein said first and second plates are essentially circular.

9. The robot of claim 1, wherein said first plate has a plurality of protrusions extending therefrom which couple to a first set of complimentary shaped apertures provided in a surface of said hub.

10. The robot of claim 1, wherein said second plate is provided with a plurality of fasteners which extend through a second set of complimentary shaped apertures provided in a wall of said first housing element.

11. The robot of claim 1, further comprising a second motor which operates a second arm by moving a second magnet disposed within said hub.

12. The robot of claim 1, wherein said hub has a flattened surface which is in contact with said substrate.

13. The robot of claim 12, wherein said substrate is sandwiched between said flattened surface and said second plate.

14. The robot of claim 1, wherein said hub is essentially annular in shape.

15. The robot of claim 1, wherein said first housing element extends through a hole in said substrate.
